(19) United States
(12) Patent Application Publication
(10) Pub. No.: US 2009/0064235 A1
(43) Pub. Date: Mar. 5, 2009

(54) Video Broadcasts with Interactive Viewer Content

(76) Inventor: Kaytaro George Sugahara, Stamford, CT (US)

Correspondence Address: Houston IP Department;JACKSON WALKER L.L.P., 1401 McKinney St., Suite 1900, Houston, TX, 77010, US

(21) Appl. No.: 12/188,780

(22) Filed: Aug. 8, 2008

Related U.S. Application Data
(60) Provisional application No. 60/963,997, filed on Aug. 8, 2007.

(51) Int. Cl. H04N 5/445; H04N 7/173

(52) U.S. Cl. 725/61; 725/87; 725/110; 725/133; 715/719

(57) ABSTRACT

Methods are provided for providing information to a viewer of a digital broadcast. Digital broadcasts which include audio components, video components, and an additional information component are transmitted to media content display devices. Information may be extracted from the information component via user activation of an information interface and selection of desired information. The desired information may be extracted from the information component of the digital broadcast and/or transmitted to a broadcaster who may then, upon receipt of the request for information, modify the information component of the digital broadcast to the viewer.

### CROSS-REFERENCE TO RELATED APPLICATION

This nonprovisional patent application claims priority to and the benefit of U.S. provisional patent application Ser. No. 60/963,997, filed on Aug. 8, 2007, which is hereby incorporated by reference.

### BACKGROUND

This invention generally relates to interactive live and pre-recorded broadcasts over computers and televisions, and more specifically relates to a method of providing additional information concerning the substance of a broadcast to a viewer on demand.

Watching sporting events on television, and more recently, via streaming video on computer systems, is very popular. These broadcasts appeal to a wide range of viewers from the very novice viewer with a rudimentary understanding of the game to the very sophisticated viewer who has knowledge of rules, strategies, statistics, etc. Sometimes the more novice fan watching a broadcast may desire additional information about the broadcast they are viewing. For example, they may wonder why a particular play develops the way it does, or be curious about a rule or player position. With current broadcasts, some of the foregoing questions may be answered with live or synchronous commentary embedded or provided in association with the broadcast itself and that appears to all viewers of the broadcast. FIG. 1 illustrates the usual method of transmitting such broadcasts and information to the viewer. Typically, any information provided to a viewer is in the form of commentary or graphics the appearance of which in the broadcast is selected and controlled by the broadcaster. If such information and commentary does not provide sufficient answers to the questions, then a viewer is left with either having the question go unanswered or looking to external sources for the information, such as books, computers, etc. This entails either “leaving” the broadcast or “interrupting” the broadcast (by known recording methods) so as to permit the information to be retrieved. This is undesirable because it interrupts the spontaneity of the broadcast and may require some substantial effort to find the answer. A more likely scenario is that the viewer continues to watch the broadcast and the question simply goes unanswered. A greater concern to the broadcaster, and to those with advertisements occurring during the broadcast, is that the viewer will move on to another broadcast because of a lack of understanding. Furthermore, it is well documented that in the practice of “television surfing,” a viewer makes up their mind within seconds of viewing a broadcast whether to move on or watch the broadcast. Without information immediately available to understand a broadcast, a viewer is more likely to move on.

One example where sports fans are likely to encounter a sporting broadcast in which they may have an interest but have little knowledge is during the Olympic games. In the case of sports broadcast during the Olympics, there are many events that are not “mainstream” and thus, viewers may have little understanding of the event. For example, curling is a long standing Olympic sport but which has a limited presence in the United States. Like any other sport, curling is governed by a set of rules, involves strategy and consists of players with different functions. All of the foregoing, however, is relatively unknown to the average American viewer. Thus, a curling broadcast which might have a great interest to viewers with knowledge of the game gets passed over by the “novice” viewer who might otherwise watch the broadcast if they had immediate access to additional information at their fingertips.

### SUMMARY

According to the preferred embodiments, a method is provided wherein a live or recorded broadcast is provided with additional substantive information about the content of the broadcast itself. More specifically, included with a broadcast is an interface that can be activated by a viewer that permits the viewer to control the presentation of additional information about broadcast. Through the interface, the viewer can obtain additional information about the substance of the broadcast. The information may include any general information that might enhance the viewers experience, such as, for example in the case of a sporting event broadcast, the rules for the particular sport, strategies of the game, description of player functions, etc. The information may also be broadcast specific, such as player roster, player statistics, team statistics, etc. The information may be presented visually or orally. Visual presentations may include text, graphics, etc. Oral presentation may include live or prerecorded commentary. Visual presentation may be on the television screen or via a remote screen, such as on a computer, a handheld device, a personal digital assistant, a telephone screen or a remote television controller.

In one preferred embodiment, the broadcast is a live broadcast of an event but includes a prerecorded commentary that provides information about the broadcast. Upon activation of the interface, a viewer may cause the prerecorded commentary to run simultaneously with the broadcast. The commentary may be only audio, or it may also include a visual component. In either case, in preferred embodiments, the audio of the broadcast could be muted while the commentary runs. In the case of a commentary with a visual component, a pop-up image may appear on the broadcast screen (the location of the image selected and/or alterable so as not to interfere with the broadcast image of the game).

In another embodiment of the foregoing, live commentary is recorded with the live broadcast. The live commentary may be activated or deactivated as desired by a viewer using the interface as the broadcast is disseminated. Of course, in the case of pre-recorded broadcasts, commentary may be pre-recorded but provided so as to either (i) be synchronous with the broadcast or event displayed with the broadcast or (ii) precede events in the broadcast to better explain an event before it occurs in the broadcast. In another embodiment, live commentary is provided with a live broadcast and the live commentary can be activated or deactivated as desired by the viewer.

In another embodiment, keywords associated with the event may be displayed upon activation of the interface and a viewer may select a keyword generated based on the content of the broadcast, thereby activating a world wide web search engine. The results of the search are then displayed for selection by the viewer.

One example of a method for providing information to a viewer of a digital broadcast comprises the steps of receiving the digital broadcast of an event wherein the digital broadcast comprises an audio digital component, a video digital component, and an information component in a digital data stream; displaying the digital broadcast on a video display; activating an information interface on the video display; displaying the information interface on the video display, wherein the information interface is user-activated; selecting a request for information from the information interface; transmitting the request for information to a broadcaster; selecting a desired format in which the information component is to be presented on the video display using the user-activated information interface; and broadcasting at least a portion of the information component in response to and in accordance with the request for information and the desired format.

Another example of a method for providing to a viewer of a digital broadcast of a sporting event certain information relating to the substantive content of the sporting event comprises the steps of: receiving the digital broadcast of the sporting event wherein the digital broadcast comprises an audio digital component, a video digital component, and an information component in a digital data stream; displaying the digital broadcast on a video display; activating an information interface and displaying the information interface on the video display, wherein the information interface is user-activated on the video display; using the activated information interface to select information related to at least one of the following: rules for the sporting event, statistics for the sport event, statistics for the teams involved in the sporting event, history of the sporting event, or an explanation of the sporting event; and broadcasting at least a portion of the information via the information component in response to and in accordance with the selected information.

Utilizing a search engine as described above, certain pre-selected words can be combined with the selected keyword, thereby narrowing the scope of the search for the search engine. Thus, a selected keyword relevant to the broadcast might be “curling.” A pre-selected word might be “rules” so that a search engine conducts a search for “curling rules.”

Yet another example of a method for providing information to a viewer of a digital broadcast comprises the steps of: displaying the digital broadcast on a video display, said digital broadcast characterized by a defined run-time; synchronizing data, having an information component with the digital broadcast, with a particular point in time in the run-time to form a synchronized information component; receiving a user request during the digital broadcast for additional information related to the digital broadcast at the particular point in time; and displaying at least a portion of the synchronized information component of the digital broadcast.

The method of the invention may be utilized with both live and pre-recorded broadcasts, viewed either on a standard television, on cable or satellite television, on a computer through a webcast as in streaming video, or any combination thereof. The embodiments herein may also be combined with any media player that displays video and audio content.

Other features and advantages of the present invention will be apparent to those skilled in the art. While numerous changes may be made by those skilled in the art, such changes are within the spirit of the invention.

### BRIEF DESCRIPTION OF DRAWINGS

A more complete understanding of the present disclosure and advantages thereof may be acquired by referring to the following description taken in conjunction with the accompanying figures, wherein:

FIG. 1 illustrates a flow diagram of the prior art where the only information provided with a broadcast is any information contained or integral in the broadcast itself.

FIG. 2 illustrates a front view of a video display which includes the interactive information interface of the invention in accordance with one embodiment of the present invention.

FIG. 3 schematically illustrates a plurality of media content display devices interacting with a broadcaster in accordance with one embodiment of the present invention.

FIG. 4 illustrates a method for displaying user-activated and user-selected content on a video display in conjunction with a digital broadcast in accordance with one embodiment of the present invention.

FIG. 5 illustrates a method for allowing a user to access and influence information concerning the substance of a broadcast using an information interface in accordance with one embodiment of the present invention.

FIG. 6 illustrates a method for allowing a user to access and influence information concerning the substance of a broadcast using an information interface in accordance with one embodiment of the present invention.

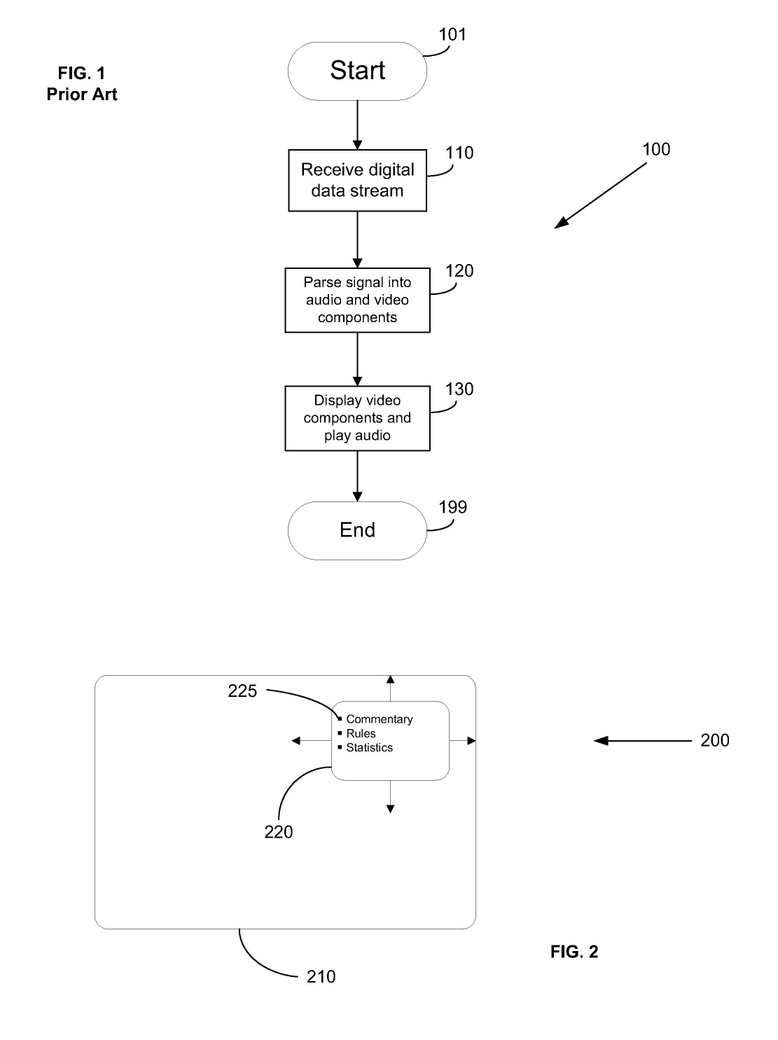

While the present invention is susceptible to various modifications and alternative forms, specific exemplary embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE PREFERRED EMBODIMENTS

The present invention generally relates to a method for interactive display of information during a broadcast, and more particularly, to a method in which a viewer of a pre-recorded or live broadcast can interactively select and display addition information related to the substance of the broadcast during the broadcast itself.

In one example of the invention, persons watching programs, live or recorded, streamed over the computer (usually via the internet) or persons watching television would have a way to ask questions in real time about the program. On a computer, this could be accomplished by clicking on an icon on the computer screen or on a icon which appeared on the screen due to some action taken by the viewer, e.g. moving the mouse or pressing on either the right or left mouse button or a combination of button. On a TV, this could be accomplished, for example, by pressing one or more buttons on a remote control or handset.

### A. Persons Watching Streaming Video Over a Computer.

Clicking on the icon would be like asking “What was that?” or What's happening?” or some similar query depending on the program being viewed. In response to the click, a text message would appear or a verbal response would be given or both answering modes would occur and give the answer to the query. Whether the answer was written, verbal or both would be up to the selection of the viewer. In one embodiment, various buttons or combinations of buttons could be assigned a different query, such as for example, during a sporting event, depressing “1” for 2 seconds will trigger the question “what was that?” while depressing “9” for 2 seconds will trigger a display of statistics for the players on the screen. Additional remotes or other input devices may be provided or used in conjunction with existing input devices.

### B. Persons Watching Television Programs.

Persons watching a television program, either live or recorded, would be able to ask questions in real time about the program they have selected to watch. Typical questions might be “What's happening?” when watching a sport, or “Who's that?” when watching a movie and the viewer would receive an immediate response, either written, verbal or both.

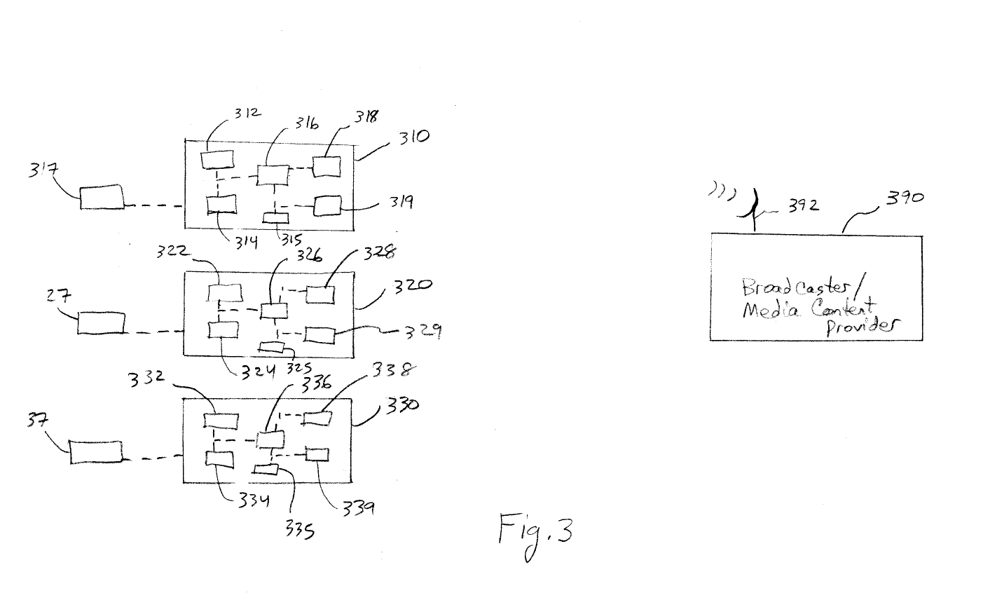

FIG. 2 shows one example of video display 200 displaying a digital broadcast on main display 210. Overlayed on top of main display 210 is information interface 220, a user interface for querying a user or viewer. Queries 225 allow the user to select or request desired information or data to be displayed in conjunction with the digital broadcast using a user input device (not shown).

### C. Source of Data

In one embodiment, for any recorded program, the data required to answer the query action would be added to the recorded program and would be recalled when the query action is executed by the viewer. For live programs, the information provided in answer to the query could be selected in real time by a person(s) at a studio, broadcast location, a “call center” type facility or other external location. Depending on the application, this selection of answer to be given to the viewer could be made by the person using a computer terminal, a specialized keyboard with many of the common answers preset or by some other suitable device such as a verbal input device.

Alternatively, keywords derived from the content of the broadcast can be either generated from the broadcast itself or transmitted with the broadcast from the studio. When a query action is executed by the viewer, one or more keywords are displayed from which the viewer can select. Selection of the keyword may prompt the display of additional information association with the keyword, or alternatively, may trigger a search engine to search the world wide web for information associated with the keyword.

### D. Actions and Equipment to Call Up the Answer.

For computer users, the query action would be initiated by clicking on an icon which would either be visible on the screen continuously or clicking on an icon which appeared on screen upon some action by the viewer such as moving the mouse or clicking one of the mouse buttons. If no mouse is used, the viewers keyboard could be substituted, programming several keys to initiate the actions needed for the query.

In one preferred embodiment, television sets and their remotes are configured to activate the system, while in another embodiment, TV viewers would utilize a special set top or similar external “box” which would acquire the required data and add it to the screen when called for. The box or external system would provide data for the right channel and would be synchronized to the program being viewed. While the term “box” is used, those skilled in the art will understand that the foregoing could comprise an electronics package that could accomplish the steps of the system.

One way to accomplish this would be for the box have to have its own system remote which would include all the functions found on a cable box remote and also functions found on the remotes of other boxes, such as a TiVo™ box remote and other digital video recorders. The system remote would be used in lieu of the cable and other box remotes. The system box would be installed as the last box just before the input to the television set.

In another embodiment, a simpler remote may be used. This remote would include a number pad used by the viewer to input the channel being viewed. The cable system subscribed to by the viewer would already be known having been input during the initial, one time setup phase of System remote usage. Those persons skilled in the art will appreciate that the System data will have to be synchronized with the television program being viewed.

The system box could get its data via the Internet or appended to the transmitted broadcast signal.

With respect to the Internet, either a wireless or wired connection would be the preferred method of connecting to the Internet but a dial up connection could be used where necessary, preferably in off-peak hours. The system box could store the data on any program to which the TV was tuned for a predetermined period of time, such as for example, more than 5 continuous minutes in certain embodiments, or the data of the program input by the viewer in other embodiments. This data could be displayed on the TV screen and/or explained verbally or both upon pressing a special button on the System remote.

In one preferred embodiment, a visual indicator on the system box, the television screen or the computer screen would illuminate when the system had data covering the program being watched.

It should be noted that the information available through the interactive interface is not just information concerning the parameters of the broadcast itself, such as length of time, title of the broadcast, rating of the broadcast or description of the broadcast. This information is considered non-substantive information or standard programming information which may be generally displayed about a program. This information may be thought of as “static” programming information Rather, the foregoing involves commentary on the program itself or underlying substantive information or dynamically generated information keyed to the actual point in the broadcast that is being viewed.

In one embodiment, the data/information is modulated with the standard broadcast signal. The data or information component of the signal is then parsed from the audio and video components of the signal at the system box or computer, as the case may be, and stored pending activation of the information interface. Once the desired information is identified, such as through the various combinations of buttons described above, the selected information can be displayed. The system then continues to monitor itself and receive and store ongoing “active” information until the broadcast is complete.

FIG. 3 schematically illustrates a plurality of media content display devices interacting with a broadcaster in accordance with one embodiment of the present invention.

Media content display devices 310, 320, and 330 receive digital broadcasts from broadcaster/media content provider 390. Each media content display device 310, 320, and 330 is shown with similar components using like-numbering. Media content display device 310 comprises video display 312, audio output device 314, processor 316, receiver 318, transmitter 319, and user input device 317.

Broadcaster 390 transmits digital broadcasts via transmission device 392. Example of suitable transmission devices include, but is not limited to, a satellite transmitters, RF transmitters, cable transmission devices (e.g. coaxial cable or fiber optic lines), or any thereof. As before, the digital broadcasts comprise an audio component, a video component, and an information component.

Receiver 318 receives the digital broadcasts makes the video and audio components available to video display 312 and audio output devices 314 by way of processor 316. A user or viewer may activate an information interface (e.g. a user interface), which then displays a query on video display 312.

The user may submit a request for additional information through the information interface. Processor 316 receives the request for information from the user and in response to the request selects the desired information from the information component of the digital broadcast and displays it video display 312. To the extent that the desired information is not available in the existing information component of the digital broadcast, media content display device 310 may transmit the request for information to broadcaster 390 via optional transmitter 319. (In another embodiment, such request may simply be the initiation of an Internet search utilizing an Internet search engine.) In any event, transmitter 319 may be any transmitter suitable for communicating the request to broadcaster 390, including, but not limited to, a telephone modem, an Internet connection, an RF transmitter, a cellular transmitter, or any combination thereof.

Upon receipt of the request for information, broadcaster 390 may modify the information component of the digital broadcast so as to make the desired information available to the user via the information component of the digital broadcast.

Alternatively, the desired information may be transmitted to and stored in memory or other data storage medium 315 and accessed from memory 315. Preferably, memory 315 collects and stores information from the information component of the digital broadcast throughout the transmission of the broadcast stream.

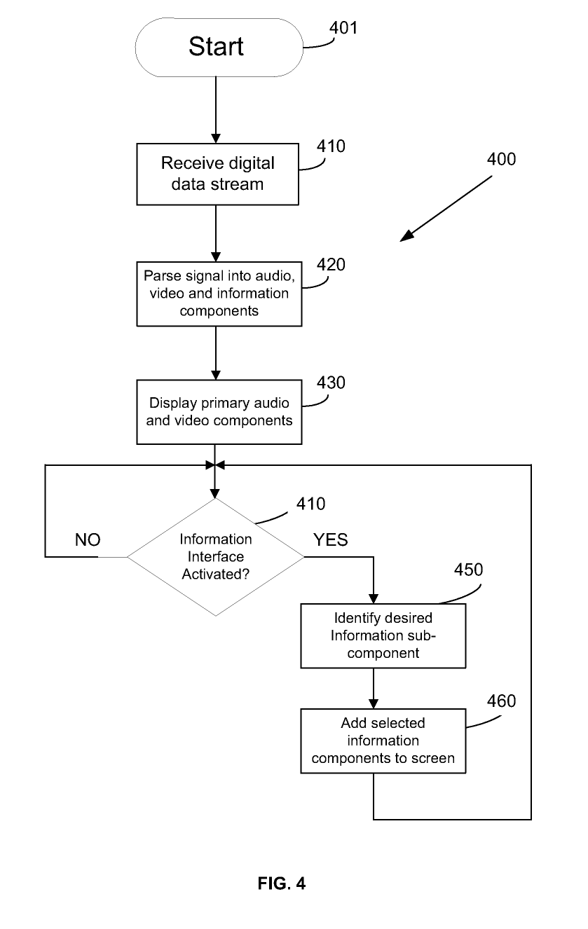

FIG. 4 illustrates a method for displaying user-activated and user-selected content on a video display in conjunction with a digital broadcast in accordance with one embodiment of the present invention.

Method 400, commencing at step 401, allows a user to activate an information interface for selecting additional desired content for viewing on a video display. A digital stream is received at step 410. The broadcast stream is parsed into an audio component, a video component, and an information component in step 420. In step 430, the audio and video components are displayed to the user. Upon activation of an information interface in step 410, the user selects a desired information sub-component in step 450. Then, the desired information, to the extent it exists in the information component or in a media storage device, is displayed to the user. In one embodiment, such information component is stored in memory in proximity to the video display (such as a set top box or memory of a computer). In another embodiment, the information component is transmitted from the broadcaster upon selection of the desired information sub-component.

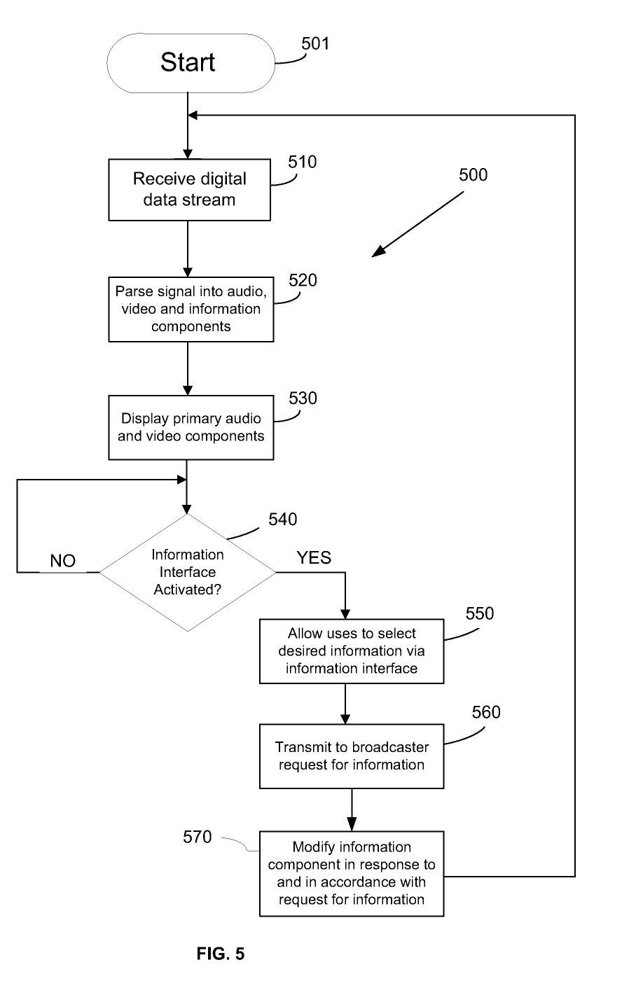

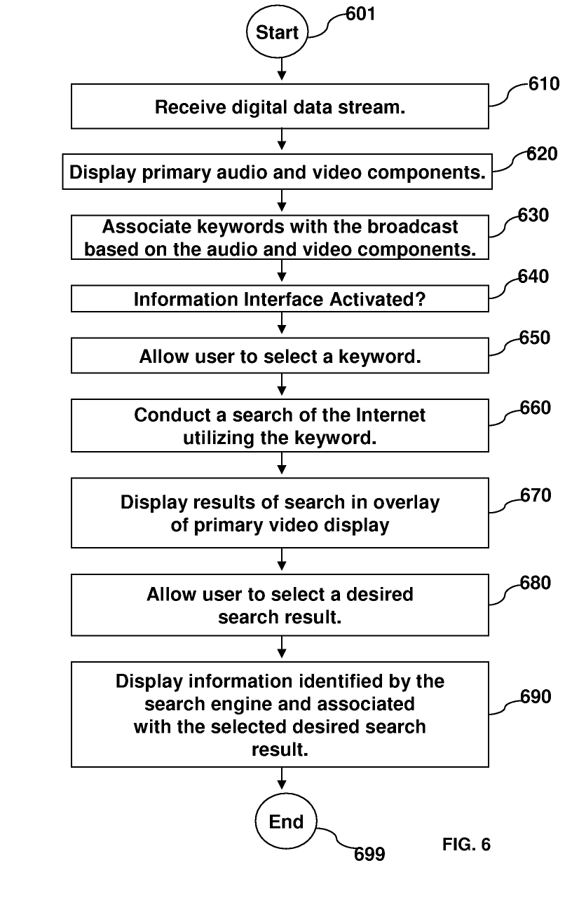

FIG. 5 illustrates a method for allowing a user to access and influence information concerning the substance of a broadcast using an information interface in accordance with one embodiment of the present invention.

Method 500, commencing at step 501, allows a user to influence a digital broadcast in real-time. A digital broadcast is transmitted by a broadcaster and subsequently received at step 510. As before, the digital broadcast comprises an audio component, a video component, and an additional information component. These components are parsed and separated at step 520. The audio and video components are displayed in step 530. At step 540, the user may activate an information interface (e.g. a user interface). At step 550, the user is allowed to submit a request for information via the information interface. Upon submission of a request for additional information, the request for information is then transmitted to the broadcaster in step 560. Upon receipt and analysis of the request for information, the broadcaster may optionally modify the information component of the information component of the digital broadcast in response to and in accordance with the request for information.

FIG. 6 illustrates a method for allowing a user to access and influence information concerning the substance of a broadcast using an information interface in accordance with one embodiment of the present invention.

Method 600, commencing at step 601, allows a user to influence a digital broadcast in real-time. A digital broadcast is transmitted by a broadcaster and subsequently received at step 610. The digital broadcast comprises an audio component and a video component. The digital broadcast may also include an information component in the form of one or more keywords. The keywords may be selected and transmitted by the broadcaster based on the content or automatically generated based on the content, as in step 630. In the case of automatic selection, such keywords may be generated at the site of the video display (such as by the set top box) or generated at the studio and transmitted with the audio and video components of the signal. For example, the audio component of the broadcast may be analyzed for recurring words or phrases to generate a keyword descriptive or that otherwise characterizes the program.

In any event, these components are parsed and separated at step 630 to the extent they are appended to the broadcast signal. At step 640, the user may activate an information interface (e.g. a user interface). The audio and video components are displayed in step 650, and the user is provided with a list of one or more keywords from which the user may choose. By choosing a key word, the user submits a request for information via the information interface. Upon submission of a request for additional information, the request for information triggers a search engine or similar search tool that searches the world wide web for additional information associated with the keyword as shown in step 660. At step 670, the results of the keyword search are displayed either in overlay fashion on the viewing screen on which the broadcast is being displayed or on the screen of a handheld unit. At step 680, the viewer may select a particular search result, in which case information associated with the search result is retrieved from the world wide web and displayed for the viewer as shown in step 690.

In this embodiment, the keyword may be combined with one or more preselected search terms to better narrow the search. Thus, for example only, search terms as “statistics,” “rules,” or “rankings,” or “teams” may be combined with the search term for use by the search engine. Those skilled in the art will appreciate that various programming options when setting up the system of the invention may provide a user with an opportunity to define what these additional terms might consist of, or control other aspects of the search, such as for example, utilizing a particular search engine or limiting the display of search engine results to only “hits” which satisfy a determined set of parameters.

In certain embodiments, the broadcaster may alter or otherwise process the data in response to and in accordance with aggregated requests for information from a plurality of media content display devices.

While the foregoing invention has been described primarily as involving digital broadcasts, those skilled in the art will appreciate that the foregoing invention could also be utilized with analog broadcasts. Moreover, while the foregoing has been described primarily with respect to the broadcast of a sporting event, those skilled in the art will appreciated that the invention may be utilized with other types of broadcasts.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Also, the terms in the claims have their plain, ordinary meaning unless otherwise explicitly and clearly defined by the patentee.

What is claimed is:

1. A method for providing information to a viewer of a digital broadcast, the method comprising the steps of:
receiving the digital broadcast of an event wherein the digital broadcast comprises an audio digital component, a video digital component, and an information component in a digital data stream;
displaying the digital broadcast on a first video display;
activating an information interface on a second video display;
displaying the information interface on the second video display, wherein the information interface is user-activated;
selecting a request for information from the information interface;
transmitting the request for information to a broadcaster;
selecting a desired format in which the information component is to be presented on the video display using the user-activated information interface; and
broadcasting at least a portion of the information component in response to and in accordance with the request for information and the desired format.

2. The method of claim 1, wherein the second video display is the first video display.

3. The method of claim 1, wherein the information component comprises pre-recorded audio-visual commentary.

4. The method of claim 3, wherein the pre-recorded audio-visual commentary is displayed on a portion of the first video display and overlays the digital broadcast.

5. The method of claim 3, wherein the pre-recorded audio-visual commentary is displayed on a portion of the second video display and overlays the digital broadcast.

6. The method of claim 3, wherein the digital broadcast is time-shifted while the audio-visual commentary is displayed.

7. The method of claim 1, wherein the digital broadcast is displayed via a television.

8. The method of claim 1, wherein the digital broadcast is displayed via streaming video and audio content via a computer over an Internet connection.

9. The method of claim 1, wherein the information component is displayed on a portion of the first video display and overlays the digital broadcast on the first video display.

10. The method of claim 1, wherein the information component is displayed on a portion of the second video display and overlays the digital broadcast on the second video display.

11. The method of claim 1, wherein the digital broadcast is live and the information component was prepared prior to the digital broadcast.

12. The method of claim 1, wherein the event is a sporting event and the information component comprises rules for the sporting event.

13. The method of claim 1, wherein the event is a sporting event and the information component comprises statistics for at least one team involved in the sporting event.

14. The method of claim 1, wherein the event is a sporting event and the information component comprises audio commentary relating to the sporting event pre-recorded prior to an occurrence of the sporting event.

15. The method of claim 1, wherein the digital broadcast is pre-recorded and the information component was prepared after an occurrence of the event but prior to the digital broadcast.

16. The method of claim 1, further comprising the steps of: associating a plurality of keywords with the broadcast based on the audio component and the video component, wherein the request for information is selected from the plurality of keywords.

17. The method of claim 1, further comprising the steps of: associating a plurality of keywords with the broadcast based on the audio component, wherein the request for information is selected from the plurality of keywords.

18. The method of claim 17, further comprising performing an Internet search relating to the request for information to produce a plurality of search results; wherein the information component comprises the plurality of search results.

19. A method for providing to a viewer of a digital broadcast of a sporting event certain information relating to the substantive content of the sporting event, the method comprising the steps of:
receiving the digital broadcast of the sporting event wherein the digital broadcast comprises an audio digital component, a video digital component, and an information component in a digital data stream;
displaying the digital broadcast on a video display;
activating an information interface and displaying the information interface on the video display, wherein the information interface is user-activated on the video display;
using the activated information interface to select information related to at least one of the following: rules for the sporting event, statistics for the sport event, statistics for the teams involved in the sporting event, history of the sporting event, or an explanation of the sporting event; and
broadcasting at least a portion of the information via the information component in response to and in accordance with the selected information.

20. The method of claim 19, wherein the information component is temporarily stored at the point of the video display.

21. The method of claim 20, wherein the information component is temporarily stored on a set-top box in communication with a television.

22. The method of claim 20, wherein the information component is transmitted independently from said audio digital component and video digital component.

23. The method of claim 21, wherein said information component is transmitted simultaneously with the audio digital component and video digital component.

24. The method of claim 22, wherein said information component is transmitted to said set-top box via the Internet.

25. The method of claim 20, wherein the information component is temporarily stored on a computer in communication with the video display.

26. The method of claim 19, wherein the digital broadcast is displayed via an Internet connection and a computer and wherein the information component is transmitted via the Internet connection to the computer only after the information interface is activated.

27. The method of claim 19, wherein the digital broadcast is displayed via the Internet connection and a computer and wherein the information component is transmitted via the Internet connection to the computer upon activation of the information interface.

28. The method of claim 19, wherein the digital broadcast is displayed via the Internet connection and a computer and the information interface is activated by selecting an icon displayed on a the video display.

29. The method of claim 19, wherein the digital broadcast is displayed via a television and the information interface is activated by utilizing a handheld wireless remote control.

30. The method of claim 29, wherein the remote control is a standard television remote control having a plurality of buttons and the information interface is activated by simultaneously holding down at least two of said buttons.

31. A method for providing information to a viewer of a digital broadcast, the method comprising the steps of:
displaying the digital broadcast on a video display, said digital broadcast characterized by a defined run-time;
synchronizing data, having an information component with the digital broadcast, with a particular point in time in the run-time to form a synchronized information component;
receiving a user request during the digital broadcast for additional information related to the digital broadcast at the particular point in time; and
displaying at least a portion of the synchronized information component of the digital broadcast.

32. The method of claim 31, wherein the user request is made by activating an information interface and displaying the user interface on the video display, wherein the information interface is user-activated.

33. The method of claim 32, wherein the activated information interface is used to select a desired information and a desired format to be presented on the video display.

34. The method of claim 33 further comprising broadcasting at least a portion of the information component in response to and in accordance with the desired information and the desired format.
